(19) United States
(12) Patent Application Publication
(10) Pub. No.: US 2010/0258254 A1
(43) Pub. Date: Oct. 14, 2010

(54) Roller door and a drive assembly for a roller door

(76) Inventors: Ben Lumbers, Holden Hill (AU); Franco Liu, Holden Hill (AU); Shiva Shankar Linge Gowda, Holden Hill (AU)

Correspondence Address: Olson & Cepuritis, LTD., 20 NORTH WACKER DRIVE, 36TH FLOOR, CHICAGO, IL, 60606, US

(21) Appl. No.: 12/661,099

(22) Filed: Mar. 10, 2010

(30) Foreign Application Priority Data
Apr. 9, 2009 (AU) 2009901549

(51) Int. Cl. E06B 9/68

(52) U.S. Cl. 160/311

(57) ABSTRACT

This invention relates to a drive assembly for a roller door. In one form the drive comprises a motor for driving the door outputting drive via a first gear form,
a means for manually driving the door outputting drive via a second gear form;
a means of selecting either of the manual or motor drive for the door,
a door curtain carrying wheel having a third gear form via which the wheel can be driven, where each of the first, second and third gear forms is or drives via one of a sun gear, an annulus gear, or the planet carrier of an epicycle gear box.

### FIELD OF THE INVENTION

This invention relates to a roller door and a drive assembly for a roller door.

For the purpose of this specification, the term roller door should be considered to be inclusive of any kind of movable barrier such as but not limited to rolling shutters and roller door curtains.

### PRIORITY

This patent application claims priority from:
Australian Provisional Patent Application 2009901549, titled “A ROLLER DOOR AND A DRIVE ASSEMBLY FOR A ROLLER DOOR”, and filed on 9 Apr. 2009. The entire content of this application is hereby incorporated by reference.

### BACKGROUND

Roller doors are in widespread use in warehouses, factories, garages and many other applications, and these roller doors are often motor driven by electric motors.

It is desirable and indeed mandatory in some cases that motor driven roller doors may also be driven manually, independently of the motorised feature. Manual operation of such doors is often achieved by way of an endless chain extending about an overhead chain pulley wheel, the chain extending down to an area adjacent ground level whereat it may be pulled by an operator in order to rotate the wheel and hence raise or lower the door.

Where a roller door is employed in a warehouse, factory or garage, the door may be very large, being either or both of high (i.e. a long door) and wide.

A problem with the above described large roller doors is that they are quite heavy, and so a large electric motor is required to drive them.

Similarly, when operation of these large doors is being manually driven, some people have difficulty raising them.

It is an object of the present invention therefore to provide a roller door and a drive assembly for a roller door that substantially ameliorate the above mentioned difficulties with and/or shortcomings of known roller doors and roller door drive assemblies, or which at least provide useful alternatives to these.

Other objects and advantages of the present invention will become apparent from the following description, taking in connection with the accompanying drawings, wherein, by way of illustration and example, an embodiment of the present invention is disclosed.

### SUMMARY OF THE INVENTION

In one aspect of this invention, there is proposed a drive assembly for a roller door comprising:
a motor for driving the door;
a means for manually driving the door;
a means of selecting either of the manual or motor drive for the door; and
means for providing a mechanical advantage to both the manual and motor drive for the door.

In a further aspect, the assembly includes a roller door adapted to be wound onto or unwound from a pair of supporting axially spaced wheels which are supported on a shaft for rotation, and the above described drive assembly for driving the roller door.

In one form, the means for providing mechanical advantage is a gear box.

In one form, the means for manually driving the door is an endless chain extending about a chain pulley wheel.

In one form, both the motor and the chain pulley wheel drive the door through a common gear box.

In one form, the means of selecting either of the manual or motor drive for the door releasably prevents one or the other of these from rotating.

In one form, each of the motor, chain pulley wheel and gear box are positioned adjacent to each other and a wheel of the roller door assembly.

In one form, the gear box is an epicyclic gear box including a sun gear, a ring gear, and a wheel which is carrying both a plurality of planet gears and a roller door curtain. Holding either of the ring or sun gear stationary and driving the other of these will cause the planet gears and wheel to be driven, thereby winding or unwinding the roller door on to or off of the wheel.

Alternatively, the wheel may include the form of the ring gear, or in yet a further alternative it may be secured to or include the form of the sun gear.

In a further aspect, the invention may be said to include a drive assembly for a roller door incorporating a gear box, wherein a plurality of planet gears carried by a planet carrier are caused to drive or be driven by either of a larger sun gear and/or a ring gear for the purpose of driving the winding and unwinding the roller door.

In one form, there are four equi-spaced planet gears.

In this respect, before explaining at least one embodiment of the invention in detail, it is to be understood that the invention is not limited in its application to the details of construction and to the arrangements of the components set forth in the following description or illustrated in the drawing. The invention is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings, which are incorporated in and constitute a part of this specification, illustrate certain embodiments of the invention, and together with the description, serve to explain the principles of the invention.

Those skilled in the art will appreciate that the conception upon which the disclosure of the invention is based may readily be utilized as a basis for designing other structures, methods, and systems for carrying out the several purposes of the present invention. It is important, therefore, to recognise that the claims should be regarded as including such equivalent constructions insofar as they do not depart from the spirit and scope of the present invention.

### BRIEF DESCRIPTION OF THE DRAWINGS

For a better understanding of this invention it will now be described with respect to an exemplary embodiment which shall be described herein with the assistance of drawings wherein:

FIG. 1 is a perspective view of one end of an exemplary roller door assembly, this end incorporating an exemplary roller door drive assembly;

FIG. 2a is a perspective view of the roller door assembly end in FIG. 1, wherein the support bracket and chain guide have been separated from the remainder of the door assembly;

FIG. 2b is a perspective view of the roller door assembly end in FIG. 1, after removal of the support bracket and chain guide;

FIG. 2c is a perspective view of the roller door assembly end in FIGS. 1 through 2b, wherein the drive assembly has been separated from the remainder of the door assembly;

FIG. 3 is a cross-sectional view through the roller door assembly end illustrated in FIG. 2b;

FIG. 4 is a perspective view of the exemplary drive assembly in isolation i.e. after its separation from the exemplary roller door assembly;

FIG. 5 is a top view of the exemplary drive assembly illustrated in FIG. 4;

FIG. 6 is an end view of the exemplary drive assembly illustrated in FIG. 4;

FIG. 7 is a side view of the exemplary drive assembly illustrated in FIG. 4;

FIG. 8 is an exploded perspective view of the drive assembly illustrated in FIG. 4;

FIG. 9 is a partially exploded perspective view of one end of an exemplary roller door assembly according to a further exemplary embodiment;

FIG. 10 is a cross-sectional view through the roller door assembly end illustrated in FIG. 9;

FIG. 11 is cross-sectional view through the roller door assembly end illustrated in FIG. 2b; and

FIG. 12 is a perspective view of a drum wheel according to a further exemplary embodiment.

In the following description, like reference characters designate like or corresponding parts throughout the several views of the drawings.

### DETAILED DESCRIPTION

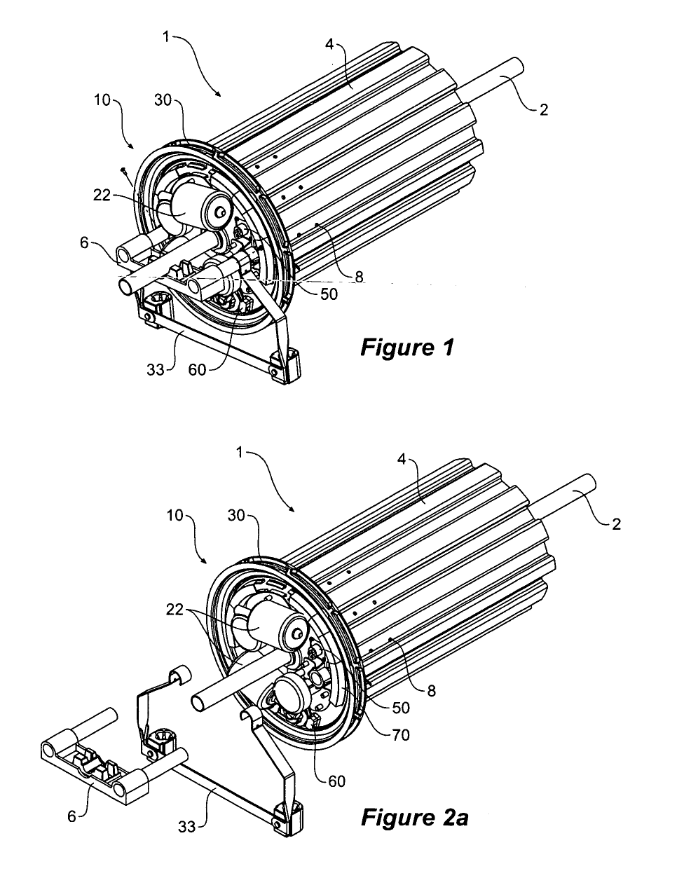

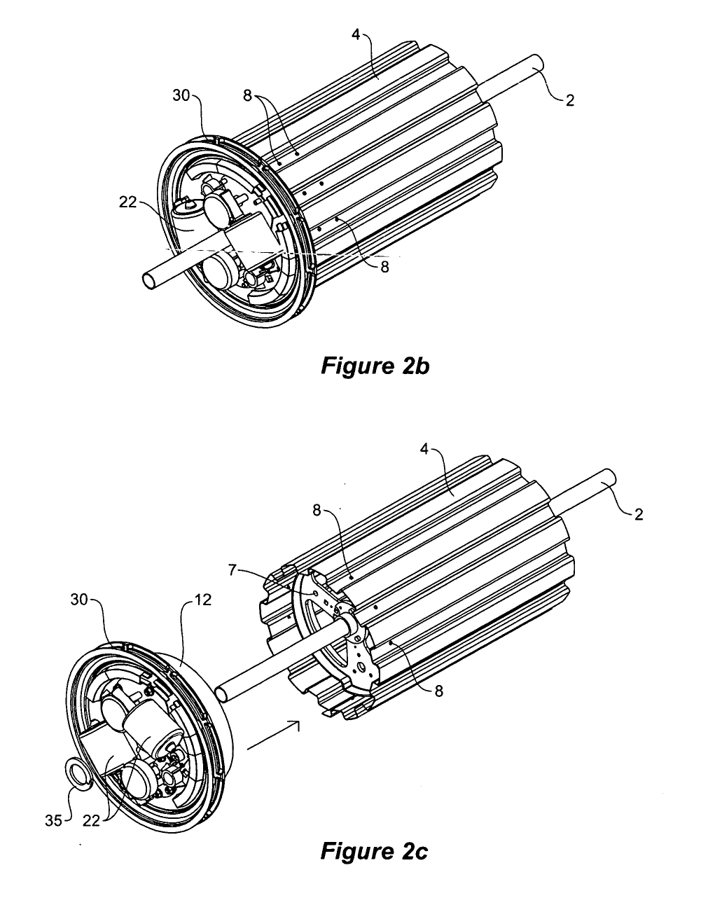

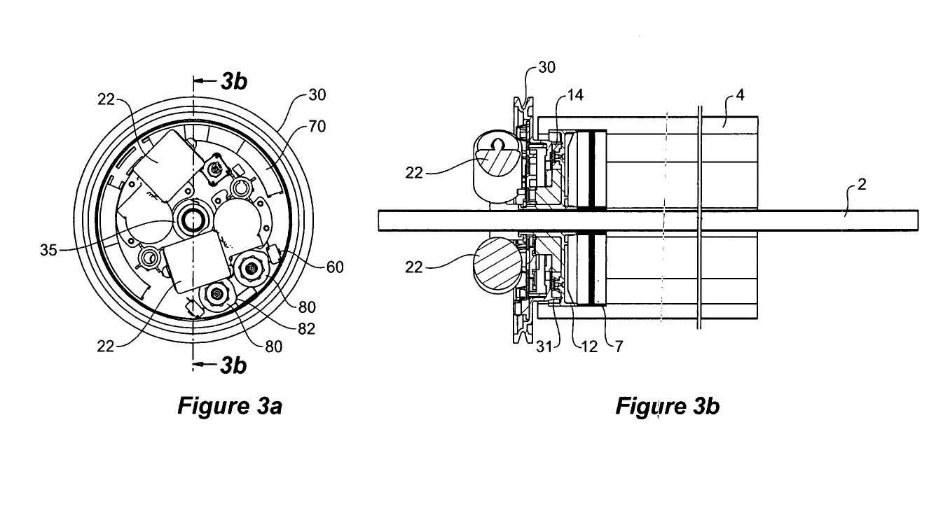

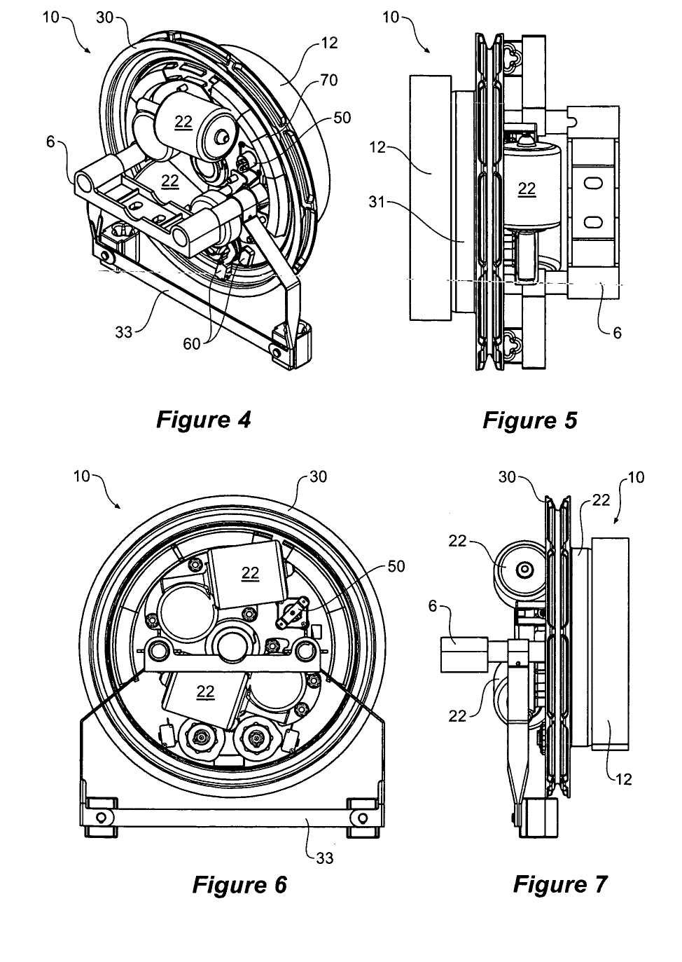

Referring now to FIGS. 1 through 2b, where there is illustrated one end of an exemplary roller door assembly 1. This roller door assembly 1 comprises a supporting shaft 2 which is adapted to be mounted above an opening in a wall by means of supporting brackets 6, which support the shaft 2 at or toward each thereof, the shaft being secured to the brackets 6 by U-bolts and threaded nuts (not shown).

With reference to FIG. 2c, it can be seen that two wheels 7 are rotatably carried on the supporting shaft 2, there being one of these wheels 7 adjacent each end thereof. The wheels 7 are of conventional design, having a hub slidably engaged on the shaft 2 and a plurality of web-like spokes extending from the hub to a rim thereof. A flexible metal door curtain 4 is wrapped or rolled up around the rim of the two wheels 7 and secured thereto using fasteners 8. The side edges of the door curtain are adapted to be slidably received in vertical channel-shaped guides (not shown) secured to the wall at opposite sides of the doorway.

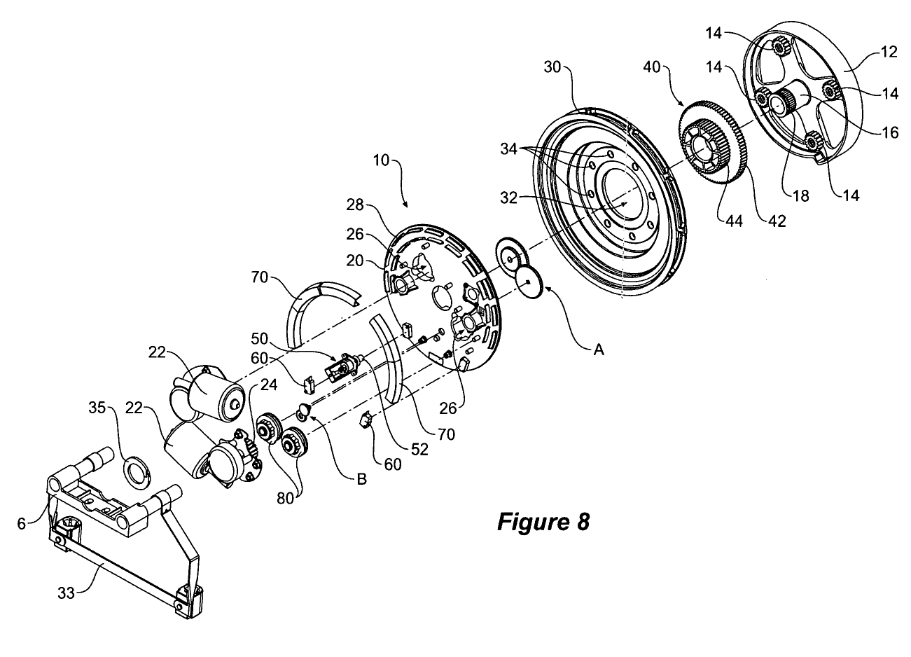

Referring now to FIG. 8, where an exemplary drive assembly 10 is illustrated. A drum wheel 12 forms part of this drive assembly 10. The drum wheel 12 comprises a hub slidably engaged on the shaft 2 and a plurality of web-like spokes extending from the hub to a rim thereof. The flexible metal door curtain 4 is wrapped or rolled up around the rim of the drum wheel 12 and secured thereto using fasteners 8 so that rotation of the drum wheel 12 will cause the door curtain 4 to be raised or lowered as desired to open or close off the opening in the wall.

The drum wheel 12 is the innermost (relative to the door curtain 4) component of the drive assembly 10, and it carries four equi-spaced pinion gears (hereinafter referred to as planet gears) 14, each having 16 teeth, on the outer side (relative to the door curtain 4) of the spokes thereof so that this drum wheel 12 forms what is known as a ‘planet carrier’. A generally cylindrical spigot 16 also extends from the centre of the drum wheel 12 on the outer side thereof. The outer surface of this spigot 16 is generally smooth, with the exception of the end 18 thereof, which has the form of a pinion gear. A bore passes through the centre of the spigot 16 so that the drum wheel 12 may be slidably disposed upon the shaft 2.

A generally disc shaped end plate 20 forms the outermost (relative to the door curtain) component of the drive assembly 10. The end plate 20 is supported by the shaft support bracket 6a so as to be rotatably fixed. Mounted to this end plate 20 is a pair (although optionally one may suffice in some instances) of reversible electric motors 22, each having an inwardly directed output pinion gear 24 of 18 teeth, where these pinion gears 24 pass through relief apertures 26 in the end plate 20.

A generally disc shape chain pulley 30 is located between the drum wheel 12 and the end plate 20. This chain pulley 30 carries the form of a ring gear 31 (see FIG. 7) having 110 teeth on a first, inwardly directed side thereof. This ring gear 31 meshes with the planet gears 14 carried on the drum wheel 12 on the outer (radially speaking) sides thereof.

A length of chain formed into a loop (not shown) extends around the chain pulley wheel 30, through chain guide 33 and down to an area adjacent ground level. When manual operation is selected, this chain may be pulled by an operator in order to rotate the chain pulley wheel 30 and hence raise or lower the door.

A sun gear set 40 is rotatably supported on the spigot 16 extending from the drum wheel 12 so as to be between the chain pulley wheel 30 and the drum wheel 12. The sun gear set 40 is not keyed to the spigot 16 so it is free to rotate relative to this. The sun gear set 40 comprises a pair of sun gears, a first, innermost gear 42 of 78 teeth, and a second outer most gear 44 of 48 teeth, which is smaller than the first gear 42. The second outer most gear projects through an aperture 32 in the centre of chain pulley wheel 30.

The components of the drive assembly 10 are held together by a split ring 35 applied to the outer side of the end plate 20. Removal of the split ring 35 permits removal of the end plate 20, and the chain pulley wheel 30 and sun gear set 40 in turn.

This first gear 42 of the sun gear set 40 meshes with the planet gears 14 carried on the drum wheel 12 on the inner (radially speaking) sides thereof.

The output pinion gears 24 of each of the motors 22 meshes with the second, outer (and smaller) gear 44 of the sun gear set 40.

It can be seen then that the drive assembly 10 incorporates an epicyclic gear box, where the drum wheel 12 is the planet carrier for the planet gears 14, and the chain pulley wheel 30 is the ring gear 31. This gear box provides a mechanical advantage of approximately 4 to 1 to both the motors 22 and the chain pulley wheel 30.

This exemplary drive assembly includes means that permit selection of either of motor 22 (i.e. automatic) or chain pulley 30 (i.e. manual) drive for the door curtain 4.

The default mode of operation for this exemplary drive assembly 10 is the automatic, or motor 22 driven mode. This is because the drive selection means is, in this exemplary embodiment, a spring loaded pin assembly 50 attached to the end plate 20 so that the pin 52 is biased so as to extend through the end plate 20 and into engagement with one of an array of eight equi-spaced holes 34 in the outer side of the chain pulley 30. Engagement of this pin 52 in one of these holes 34 locks the chain pulley wheel 30 to the end plate 20, thereby preventing its rotation.

With the ring gear 31 of the chain pulley wheel 30 unable to rotate due to its being held by the spring loaded pin 52, operation of the electric motors 22 will drive the sun gear set 40, which will in turn drive the drum wheel 12 (via the planet gears 14) thereby causing the door curtain 4 to be either raised or lowered.

When required, the spring loaded pin 52 can be disengaged (against the bias of the spring) from its engagement with a hole 34 in the chain pulley wheel 30. Actuation of the spring loaded pin 52 may be remotely operated by a cable extending down to ground level or perhaps via a solenoid.

In this scenario (i.e. manual operation of the door) the motors are not used (possibly due to power failure, fire etc.), so the sun gear set 40 remains stationary whilst the ring gear 31 formed into the chain pulley wheel 30 rotates against the planet gears 14 causing the drum wheel 12 to be driven. This thereby causes the door curtain 4 to be either raised or lowered.

When in automatic mode, once one or both of the motors 22 are set in motion to drive the door curtain 4, operation of these motors 22 is maintained until these are deactivated by limit switches 60 attached to the outer side of the end plate 20. Wiring (not shown) extending between these switches 60 and the motors 22 is routed through channels 28 enclosed by clip on covers 70. Operation of these switches 60 is triggered by the lobes 82 of a pair of cam wheels 80 that are driven off of the drum wheel 12 by its spigot pinion gear at 18 through gear sets A and B.

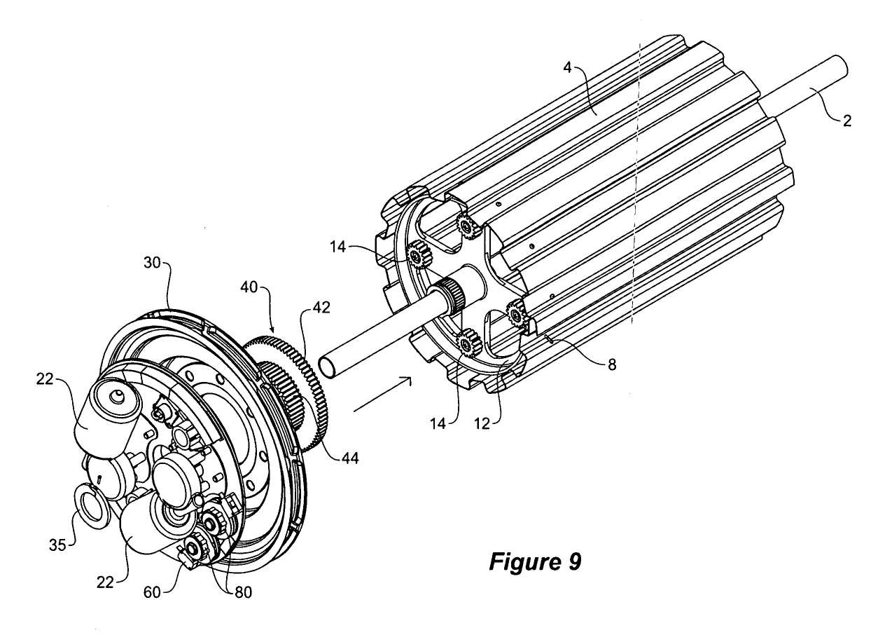

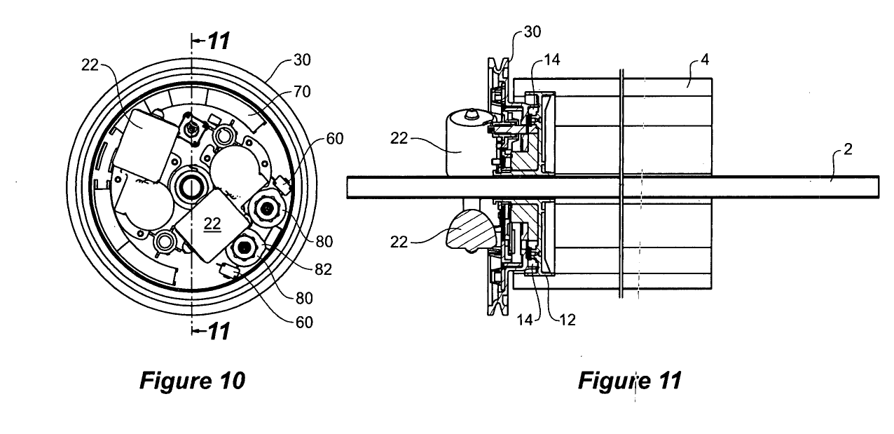

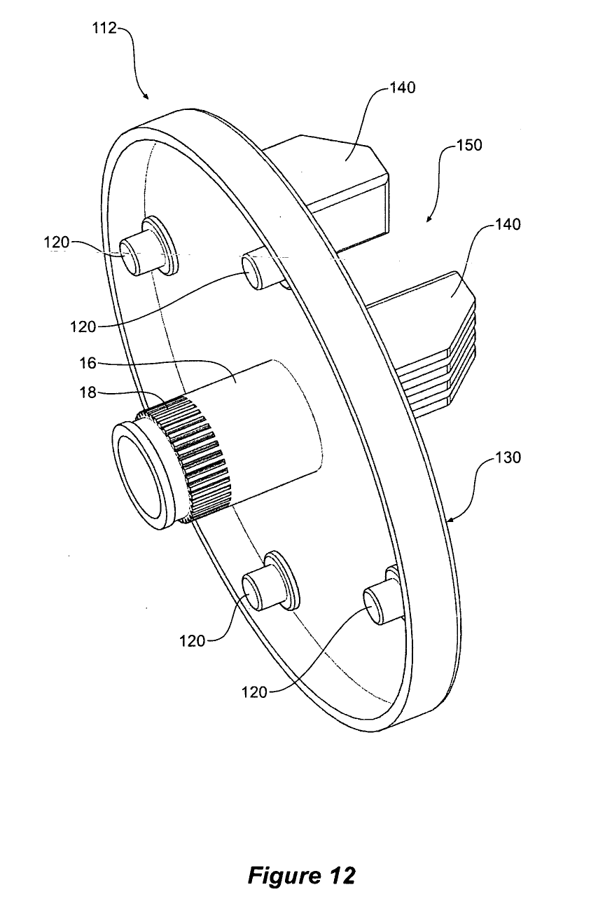

Referring now to FIGS. 9 and 10, where there is illustrated a roller door assembly 100 according to a further exemplary embodiment, which comprises a door drive assembly 10 identical to that discussed above. Roller door assembly 100 differs from roller door assembly 1 in that it does away with wheel 7 (refer FIG. 2c) at the drive assembly 10 end thereof, so that the door curtain 4 is secured directly to the rim of drum wheel 12.

Referring now to FIG. 12, where there is illustrated an alternative drum wheel 112 for the drive assembly 10. A drive assembly 10 can be assembled with a drum wheel 112 in place of drum wheel 12 so as to adapt the drive assembly 10 for retrofit with any existing roller door installation.

As was the case with drum wheel 12, the drum wheel 112 carries the four equi-spaced pinion gears (hereinafter referred to as planet gears) 14, on pins 120 formed on the outer side (relative to the existing door assembly) so that this drum wheel 112 forms the ‘planet carrier’. A generally cylindrical spigot 16 also extends from the centre of the drum wheel 112 on the outer side thereof. The outer surface of this spigot 16 is generally smooth, with the exception of the end 18 thereof, which has the form of a pinion gear.

On the inner side 130 of drum wheel 112 there are a pair of spaced apart jaws 140 defining a gap 150 therebetween. In use, the drive assembly 10 with drum wheel 112 can be positioned adjacent the end of an existing roller door installation and the jaws 140 located either side of a spoke of one the wheels that rotatably support the existing roller door. In this way, the installed drive assembly 10 can drive this wheel via drum wheel 112 and thereby effect raising and lowering of the existing roller door.

A significant advantage of the exemplary drive assembly 10 disclosed herein is that the mechanical advantage conferred by the epicyclic gear box reduces the input torque required from either of the electric motors 22 or the person pulling upon the chain of the chain pulley wheel 30. Flow on effects of this include:
1. Smaller electric motors 22 are required; and
2. Less effort is required to raise the door manually.

A further advantage is that the drive assembly 10 is a module, so a worn drive assembly can be replaced without the need to replace an otherwise serviceable door curtain 4.

Yet a further advantage is the ease with which a worn motor 22 can be replaced, due in part to their smaller size and accessibility.

Yet a still further advantage is the compactness of the drive assembly arrangement 10, where all of the major components thereof are packaged close to the end of the door curtain 4.

Yet a still further advantage is both the uniform distribution of load (and therefore stress) imparted on the drum wheel 12 and the significantly improved drive imparted by virtue of the fact that this arrangement employs four equi-spaced planet gears 14 to drive the drum wheel 12. It is known that certain roller doors and roller door drive assemblies of the prior art employ a single pinion gear driving a ring gear on the drum wheel. Such an arrangement places all of the drive load through a single mesh point increasing the likelihood of slippage or indeed failure. Moreover, such an arrangement creates a side loading that must be counteracted by the drum wheel and support shaft. Such side loads are eliminated in the exemplary drive assembly 10, as the side load created by each planet gear 14 is counteracted by the side load of an opposing planet gear 14.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

Although the disclosure has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1-17. (canceled)

18. A drive assembly for a roller door comprising:
a motor for driving the door;
a manual arrangement for driving the door; and
a transmission for transmitting drive from at least one of the motor and the manual drive arrangement to the door, wherein the at least one of the motor or manual drive arrangement can be selected to drive the door, and the transmission provides a mechanical advantage to the selected at least one motor or manual drive arrangement.

19. The drive assembly of claim 18, wherein the transmission is a gear box.

20. The drive assembly of claim 18, wherein the transmission comprises an epicyclic gearing system.

21. The drive assembly of claim 20, wherein selection of the at least one of the motor or the manual drive arrangement is performed by holding or leaving stationary one of a planet carrier, an annulus or a sun gear of the epicyclic gearing system.

22. The drive assembly of claim 18, further comprising a pair of axially spaced wheels rotatably supported on a shaft, the axially spaced wheels supporting the roller door such that the door can be wound onto or unwound from the wheels.

23. The drive assembly as in claim 18, wherein the motor outputs drive via a first gear form,
the manual drive arrangement outputs drive via a second gear form; and a door curtain carrying wheel comprises a third gear form via which the wheel can be driven,
where each of the first, second and third gear forms transmits drive via one of a sun gear, an annulus gear, or a planet carrier of an epicycle gearing system.

24. The drive assembly as in claim 23, wherein the door curtain carrying wheel comprises a planet carrier supporting a plurality of planet gears, the second gear form of the manual drive arrangement is an annulus gear, and the first gear form of the motor is a pinion driving via a sun gear.

25. The drive assembly as in claim 24, wherein with the annulus gear fixed, operation of the motor drives the sun gear, which in turn drives the door curtain supporting wheel via its planet gears causing the door curtain to raise or lower.

26. The drive assembly as in claim 24, wherein with the annulus gear released and the motor dormant, the sun gear remains stationary as the annulus gear is driven to rotate against the planet gears causing the door curtain supporting wheel to be driven and the door curtain to be either raised or lowered.

27. The drive assembly as in claim 18, wherein the manual drive arrangement comprises an endless chain extending about a chain pulley wheel.

28. The drive assembly as in claim 27, wherein the chain pulley wheel comprises an a second annulus gear.

29. The drive assembly as in claim 18, wherein the manual drive arrangement comprises a handle driven winch.

30. The drive assembly as in claim 18, comprising a plurality of motors to drive the door.

31. The drive assembly as in claim 21, wherein the epicyclic gearing system is adjacent a door curtain carrying wheel.

32. A drive assembly for a roller door comprising:
a motor for driving the door, the motor outputting drive via a first gear form;
a manual drive arrangement for driving the door, the manual drive arrangement outputting drive via a second gear form, and a door curtain carrying wheel operatively connected to a third gear form via which the door curtain carrying wheel can be driven, where each of the first, second and third gear forms drives via one of a sun gear, an annulus gear, or the planet carrier of an epicycle gear system.

33. The drive assembly of claim 32, wherein selection of the at least one of the motor or the manual drive arrangement is performed by holding or leaving stationary one of a planet carrier, an annulus or a sun gear of the epicyclic gearing system.

34. A drive assembly for a roller door comprising:
a motor for driving the door, the motor outputting drive via a pinion driving a sun gear of an epicycle gear system;
a manual drive for driving the door, the manual drive outputting drive via a wheel comprising an annulus gear of the epicycle gear system, and
a door curtain carrying wheel operatively connected to a planet carrier of the epicycle gear system, via which the door curtain carrying wheel can be driven,
wherein selection of the at least one of the motor or the manual drive arrangement is performed by holding or leaving stationary one of the pinion or annulus gear of the epicycle gear system.
